(19) United States
(12) Patent Application Publication
(10) Pub. No.: US 2026/0029528 A1
(43) Pub. Date: Jan. 29, 2026

(54) APPARATUS AND METHOD FOR LINEAR OBJECT DETECTION

(71) Applicant: HYUNDAI MOBIS CO., LTD., Seoul (KR)

(72) Inventor: Dong Yun Son, Yongin-si (KR)

(73) Assignee: HYUNDAI MOBIS CO., LTD., Seoul (KR)

(21) Appl. No.: 19/274,343

(22) Filed: Jul. 18, 2025

(30) Foreign Application Priority Data
Jul. 23, 2024 (KR) 10-2024-0097230

(51) Int. Cl. G01S 15/931; G01S 7/539; G01S 15/46; G01S 15/86; G01S 15/87

(52) U.S. Cl. CPC G01S 15/931; G01S 7/539; G01S 15/46; G01S 15/86; G01S 15/87; G01S 2015/932; G01S 2015/938

(57) ABSTRACT

Disclosed is an apparatus for detecting a linear object, the apparatus including: an ultrasonic sensor including first, second, third and fourth ultrasonic sensor units, each of which is configured to transmit a signal toward an object and receive signals of direct waves and indirect waves reflected from the object; an ultrasonic signal preprocessor configured to preprocess the direct waves and indirect waves received in each of the first, second, third and fourth ultrasonic sensor units and detect a direct wave time-of-flight (TOF) and an indirect wave TOF; a linear object identifier configured to identify a linear object based on at least one of the direct wave TOF and the indirect wave TOF; and a controller configured to control braking of a vehicle based on the linear object.

This application claims the benefit of Korean Patent Application No. 10-2024-0097230, filed on Jul. 23, 2024, which is hereby incorporated by reference as if fully set forth herein.

### BACKGROUND

### Technical Field

The present embodiments may be applied to autonomous vehicles in all fields, and more specifically to a vehicle system including, for example, an ultrasonic sensor.

### Discussion of the Related Art

Ultrasonic sensors mounted to the front or rear bumpers, or other vehicle bodies of a vehicle are important components for a parking assistance system or rear parking sensors. The ultrasonic sensors detect obstacles behind or beside the vehicle to help a driver avoid collisions when parking.

The ultrasonic sensors periodically transmit high-frequency sound waves (or ultrasonic waves), and receive signals of the ultrasonic waves reflected from the obstacles. A direct wave refers to that a signal transmitted by the ultrasonic sensor and reflected from an obstacle is directly received in that ultrasonic sensor, and an indirect wave refers to that a signal transmitted by the ultrasonic sensor and reflected from an obstacle is received in another ultrasonic sensor. If there are two other ultrasonic sensors on both sides of the ultrasonic sensor, the ultrasonic sensor receives one direct wave and two indirect waves. The ultrasonic sensor can estimate the position of a reflection point (i.e., obstacle) based on two intersections of the one direct wave and the two indirect waves.

The location of the obstacle may be estimated based on time of flight (TOF) values obtained by the ultrasonic sensors, hereinafter referred to as ultrasonic sensor data.

In this case, a conventional ultrasonic sensor has its own reference, and saves the corresponding data as the ultrasonic sensor data only when the amplitude of the ultrasonic wave exceeds the reference. Therefore, the ultrasonic sensor detects obstacles in a high position (e.g., a parking pillar, or an object capable of damaging the vehicle) without detecting obstacles in a low position (e.g., gravel, a stopper, a low kerb, etc.).

However, the conventional ultrasonic sensor has a problem in that a lot of ultrasonic waves are detected because the amplitude of a linear object having a low height and being angled is measured to be high even though the reference is appropriately controlled.

### SUMMARY

An embodiment of the disclosure is to provide a linear object detection apparatus and method for identifying the shape of a linear object with a high amplitude of ultrasonic waves.

It will be appreciated by persons skilled in the art that the aspects that could be achieved with the present disclosure are not limited to what has been particularly described hereinabove and the above and other aspects that the present disclosure could achieve will be more clearly understood from the following detailed description.

To solve the foregoing problems, according to any one of embodiments of the disclosure provides an apparatus for detecting a linear object, including: an ultrasonic sensor including first, second, third and fourth ultrasonic sensor units, each of which is configured to transmit a signal toward an object and receive signals of direct waves and indirect waves reflected from the object; an ultrasonic signal preprocessor configured to preprocess the direct waves and indirect waves received in each of the first, second, third and fourth ultrasonic sensor units and detect a direct wave time-of-flight (TOF) and an indirect wave TOF; a linear object identifier configured to identify a linear object based on at least one of the direct wave TOF and the indirect wave TOF; and a controller configured to control braking of a vehicle based on the linear object

According to an embodiment, the ultrasonic signal preprocessor may include: an ultrasonic signal primary wave preprocessing unit configured to set a distance value of the first signal, which exceeds a preset reference among the detected TOFs, as a primary TOF; and an ultrasonic signal secondary wave preprocessing unit configured to set a distance value of the second signal, which exceeds a preset reference among the detected TOFs, as a secondary TOF.

According to an embodiment, the linear object identifier may be configured to: identify the object as a primary linear object based on the primary TOF, upon all the same preprocessed primary direct wave TOF values; and identify the object as a secondary linear object based on the secondary TOF, upon all the same preprocessed secondary direct wave TOF values.

According to an embodiment, the controller may be configured to hold off on controlling the braking of the vehicle, upon a risk of collision between the primary linear object and the vehicle.

According to an embodiment, the controller may be configured to identify whether the secondary direct wave TOF is twice the primary direct wave TOF, upon the presence of the secondary linear object.

According to an embodiment, the controller may be configured to: identify the secondary linear object as a braking target for the vehicle, upon the secondary TOF twice the primary TOF, and control the braking corresponding to the braking target.

According to an embodiment, the linear object identifier may be configured to: select two adjacent ultrasonic sensor units among the first, second, third and fourth ultrasonic sensor units; and identify whether the direct wave TOFs received in the selected ultrasonic sensor units have the same distance value.

According to an embodiment, the linear object identifier may be configured to select one of the two adjacent ultrasonic sensor units as a transmission sensor and the other as a reception sensor, upon the direct wave TOFs received in the selected ultrasonic sensor units and having the same distance value.

According to an embodiment, the linear object identifier may be configured to calculate an ideal indirect wave TOF of a linear object, upon the reception sensor receiving the indirect wave TOF from the transmission sensor.

According to an embodiment, the linear object identifier may be configured to: identify whether the received indirect wave TOF and the ideal indirect wave TOF are within an error range; accumulates the number of indirect waves, upon the received indirect wave TOF and the ideal indirect wave TOF being within the error range; and identify the object as a linear object, upon an accumulated number of indirect waves being greater than or equal to a threshold value.

### BRIEF DESCRIPTION OF THE DRAWINGS

FIG. 1 is a block diagram of an entire autonomous driving control system to which an autonomous driving device according to any one of embodiments of the disclosures is appliable;

FIG. 2 is a diagram illustrating an example that an autonomous driving device according to any one of embodiments of the disclosure is applied to an autonomous vehicle;

FIG. 3 is a block diagram illustrating an apparatus for detecting a linear object according to any one of embodiments of the disclosure;

FIG. 4 is a diagram illustrating a method of detecting a linear object in an open area according to an embodiment of the disclosure;

FIG. 5 is a flowchart showing a method of detecting a linear object in an open area according to an embodiment of the disclosure;

FIG. 6 is a diagram illustrating a method of detecting a linear object in a parking space according to an embodiment of the disclosure; and

FIG. 7 is a flowchart showing a method of detecting a linear object in a parking space according to an embodiment of the disclosure.

### DETAILED DESCRIPTION

Below, embodiments of the disclosure will be described in detail with reference to the accompanying drawings, so that a person having ordinary knowledge in the art to which the disclosure pertains can easily implement the disclosure. However, the disclosure may be implemented in various different forms and is not limited to the embodiments described herein. In addition, to clearly describe the disclosure, parts unrelated to the description are omitted from the drawings, and like numerals refer to like elements throughout the specification.

Throughout the specification, unless explicitly described to the contrary, the term “include” will be understood to imply the inclusion of stated elements but not the preclusion of any other elements, unless stated otherwise.

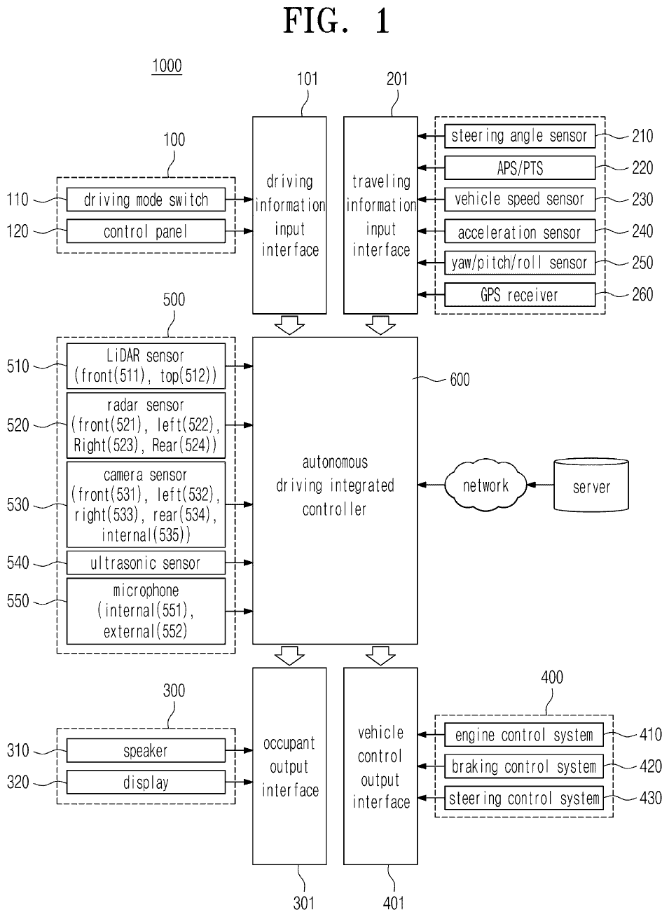

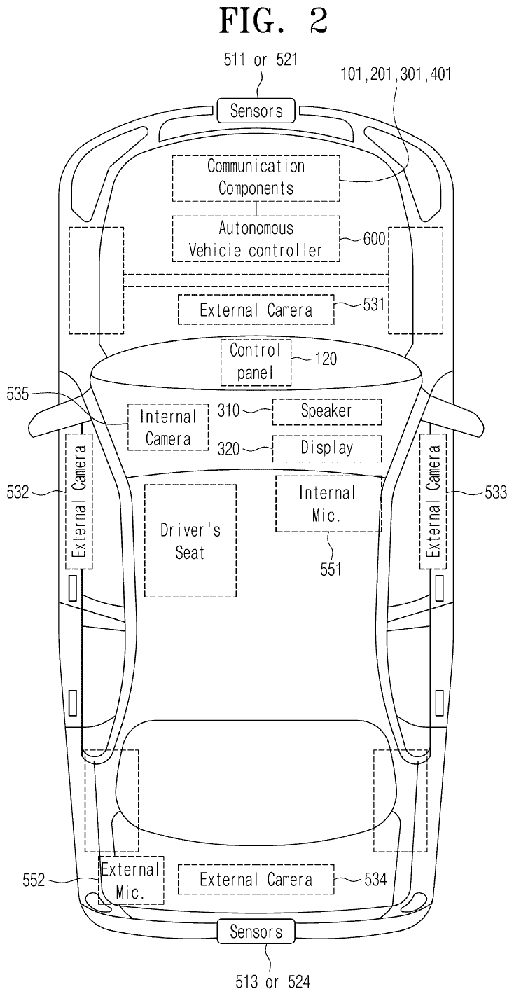

FIG. 1 is an overall block diagram of an autonomous driving control system to which an autonomous driving apparatus according to any one of embodiments of the present disclosure is applicable. FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LiDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

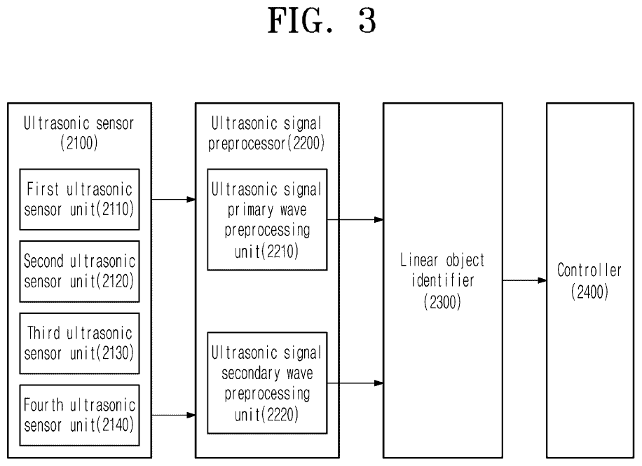

FIG. 3 is a block diagram illustrating an apparatus for detecting a linear object according to any one of embodiments of the disclosure.

Referring to FIG. 3, an apparatus 2000 for detecting a linear object may include an ultrasonic sensor 2100, an ultrasonic signal preprocessor 2200, a linear object identifier 2300, and a controller 2400.

The ultrasonic sensor 2100 may be placed at any suitable location outside the vehicle to detect objects located in front of, behind or beside the vehicle.

The ultrasonic sensor 2100 may detect an object behind the vehicle through four ultrasonic sensor units positioned at the rear of the vehicle. The ultrasonic sensor 2100 may include a first ultrasonic sensor unit 2110 positioned on a left outward side at the rear of the vehicle, a second ultrasonic sensor unit 2120 positioned on a left inward side at the rear of the vehicle, a third ultrasonic sensor unit 2130 positioned on a right inward side at the rear of the vehicle, and a fourth ultrasonic sensor unit 2140 positioned on a right outward side at the rear of the vehicle.

The first, second, third and fourth ultrasonic sensor units may transmit signals toward an object and receive signals of direct waves and indirect waves reflected from the object, respectively. In this case, the first, second, third and fourth ultrasonic sensor units may have their own references, and each ultrasonic sensor unit may receive data of an ultrasonic signal when the amplitude of the ultrasonic wave reflected from an obstacle exceeds the reference.

In the present embodiment, it will be described by way of example that the ultrasonic sensor is divided into the first, second, third and fourth ultrasonic sensor units, each of which outputs the signal of the same frequency to transmit and receive the direct and indirect waves, but the technical scope of the disclosure is not limited to this example.

The ultrasonic signal preprocessor 2200 may receive the signals received in the respective ultrasonic sensor units of the ultrasonic sensor 2100, and detect at least one of direct wave time-of-flight (TOF) and indirect wave TOF based on a TOF method.

For example, the ultrasonic signal preprocessor 2200 may preprocess the direct and indirect waves respectively received in the first, second, third and fourth ultrasonic sensor units 2110, 2120, 2130, and 2140 to detect the direct wave TOF and the indirect wave TOF.

To this end, the ultrasonic signal preprocessor 2200 may calculate a TOF value according to a distance value by calculating a distance from an object based on the ultrasonic waves transmitted to and reflected from the object.

The ultrasonic signal preprocessor 2200 may include an ultrasonic signal primary wave preprocessing unit 2210 to preprocess a primary wave among the ultrasonic waves received in the ultrasonic sensor 2100, and an ultrasonic signal secondary wave preprocessing unit 2220 to preprocess a secondary wave.

The ultrasonic signal primary wave preprocessing unit 2210 may detect a distance value of the first signal, which exceeds a preset reference among the TOFs detected by the first, second, third and fourth ultrasonic sensor units 2110, 2120, 2130 and 2140, as a primary TOF.

In this case, the ultrasonic signal primary wave preprocessing unit 2210 may detect the primary direct wave TOF and the primary indirect wave TOF based on the direct waves and the indirect waves reflected from the object and respectively received in the first, second, third and fourth ultrasonic sensor units 2110, 2120, 2130, and 2140.

The ultrasonic signal secondary wave preprocessing unit 2220 may detect a distance value of the second signal, which exceeds a preset reference among the TOFs detected by the first, second, third and fourth ultrasonic sensor units 2110, 2120, 2130 and 2140, as a secondary TOF.

In this case, the ultrasonic signal secondary wave preprocessing unit 2220 may detect the secondary direct wave TOF and the secondary indirect wave TOF based on the direct waves and the indirect waves reflected from the object and received by the first, second, third and fourth ultrasonic sensor units 2110, 2120, 2130, and 2140, respectively.

The present embodiment shows an example that the ultrasonic signal preprocessor 2200 is divided into the ultrasonic signal primary wave preprocessing unit 2210 and the ultrasonic signal secondary wave preprocessing unit 2220, each of which preprocesses different ultrasonic signals. However, the technical scope of the disclosure is not limited to this example, and signals different in amplitude from each other may be preprocessed by a single ultrasonic signal preprocessor.

The linear object identifier 2300 may identify a linear object based on at least one of the direct wave TOF and the indirect wave TOF.

The linear object identifier 2300 may use the primary TOF and the secondary TOF to identify a linear object.

When all the preprocessed primary direct wave TOF values are the same, the linear object identifier 2300 may identify an object as a primary linear object based on the primary TOF.

When all the preprocessed secondary direct wave TOF values are the same, the linear object identifier 2300 may identify an object as a secondary linear object based on the secondary TOF.

For example, the linear object identifier 2300 may identify a linear object having a low height based on the primary TOF. The linear object identifier 2300 may identify a linear object having a high height based on the secondary TOF.

Meanwhile, the linear object identifier 2300 may identify the linear object based on the direct wave TOF and the indirect wave TOF of each of the first, second, third and fourth ultrasonic sensor units 2110, 2120, 2130, and 2140 preprocessed by the ultrasonic signal preprocessor 2200. In this case, the direct wave TOF refers to a distance value of the signal when the sensor unit of transmitting the ultrasonic waves and the sensor unit of receiving the ultrasonic waves are the same, and the indirect wave TOF refers to a distance value of the signal when the sensor unit of transmitting the ultrasonic waves and the sensor unit of receiving the ultrasonic waves are different.

The linear object identifier 2300 may select two adjacent ultrasonic sensor units among the first, second, third and fourth ultrasonic sensor units 2110, 2120, 2130, and 2140, and identify whether the direct wave TOFs received in the selected ultrasonic sensor units have the same distance value.

When the direct wave TOFs received in the selected ultrasonic sensor units have the same distance value, the linear object identifier 2300 may select one of the two adjacent ultrasonic sensor units as a transmission sensor and the other as a reception sensor.

When the reception sensor receives the indirect waves from the transmission sensor, the linear object identifier 2300 may calculate an ideal indirect wave TOF corresponding to the linear object.

The linear object identifier 2300 may identify whether a difference between the indirect wave TOF based on the received indirect wave and the ideal indirect wave TOF is within an error range.

When the difference is within the error range, the linear object identifier 2300 accumulates the number of indirect waves. When an accumulated number of indirect waves is greater than or equal to a threshold value, the linear object identifier 2300 may identify the object as a linear object.

The controller 2400 may control braking of the vehicle based on the linear object identified by the linear object identifier 2300.

The controller 2400 may control the braking of the vehicle according to the identification of a primary linear object based on the primary TOF.

For example, the controller 2400 may hold off on controlling the braking of the vehicle when there is a risk of collision between a primary linear object and the vehicle. In this way, the controller 2400 may prevent false braking based on the identification of the primary linear object.

In addition, the controller 2400 may control the braking of the vehicle according to the identification of a secondary linear object based on the secondary TOF.

For example, when the secondary linear object is present, the controller 2400 may identify whether the secondary direct wave TOF value is twice the primary direct wave TOF value. When the secondary direct wave TOF value is twice the primary direct wave TOF value, the controller 2400 may identify the secondary linear object as a braking target. Then, the controller 2400 may perform the braking control corresponding to the braking target. In this way, the controller 2400 may improve the braking performance of the vehicle based on the identification of the secondary linear object.

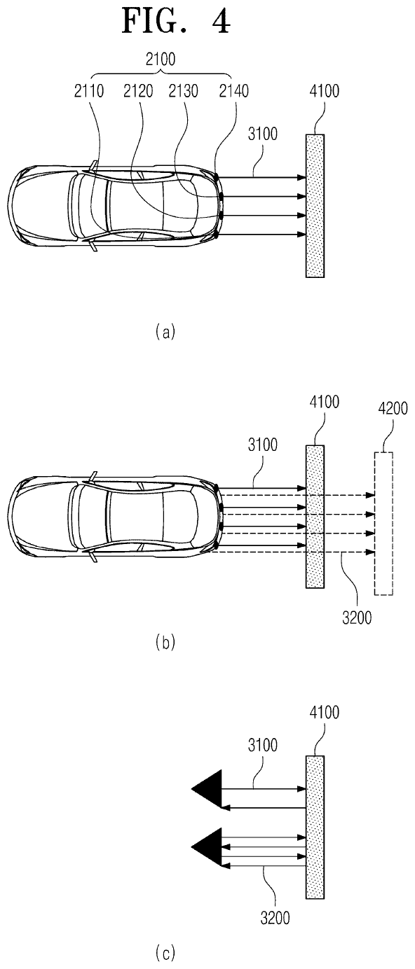

FIG. 4 is a diagram illustrating a method of detecting a linear object in an open area according to an embodiment of the disclosure.

Referring to FIG. 4(a), the linear object identifier 2300 according to an embodiment of the disclosure may identify the state of a detected object based on the primary direct wave TOF 3100 preprocessed by the ultrasonic signal preprocessor 2200. In this way, the linear object identifier 2300 may identify whether the detected object is the linear object. In other words, the linear object identifier 2300 may identify whether a wall 4100 detected based on the preprocessed primary direct wave TOF is the linear object.

The linear object identifier 2300 may identify whether all the respective primary direct wave TOFs by the first, second, third and fourth ultrasonic sensor units 2110, 2120, 2130, and 2140 are present.

The linear object identifier 2300 may cancel the object state identification when any one of the first, second, third and fourth ultrasonic sensor units 2110, 2120, 2130, and 2140 fails to detect the primary direct wave TOF.

On the other hand, when all the primary direct wave TOFs are present, the linear object identifier 2300 may identify whether the primary direct wave TOFs of the first, second, third and fourth ultrasonic sensor units 2110, 2120, 2130, and 2140 have the same value.

For example, the linear object identifier 2300 may identify whether four primary direct wave TOFs have the same value during two update cycles of the ultrasonic sensor unit. When four primary direct wave TOFs do not have the same value, the linear object identifier 2300 may identify that the detected object is not the linear object.

Therefore, the linear object identifier 2300 may identify the detected object as the primary linear object when the primary direct wave TOFs have the same value.

Referring to FIG. 4(b), the linear object identifier 2300 according to an embodiment of the disclosure may identify the state of the detected object based on the secondary direct wave TOF 4100 preprocessed by the ultrasonic signal preprocessor 2200. The linear object identifier 2300 may identify whether a virtual wall 4200 having a high height, such as the wall 4100, is the linear object, based on the secondary direct wave TOFs. The linear object identifier 2300 may identify whether all the secondary direct wave TOFs by the first, second, third and fourth ultrasonic sensor units 2110, 2120, 2130, and 2140 are present.

The linear object identifier 2300 may cancel the object state identification when any one of the first, second, third and fourth ultrasonic sensor units 2110, 2120, 2130, and 2140 fails to detect the secondary direct wave TOF.

On the other hand, when all the secondary direct wave TOFs are present, the linear object identifier 2300 may identify whether the secondary direct wave TOFs of the first, second, third and fourth ultrasonic sensor units 2110, 2120, 2130, and 2140 have the same value.

For example, the linear object identifier 2300 may identify whether four secondary direct wave TOFs have the same value during three update cycles of the ultrasonic sensor unit.

When the secondary direct wave TOFs have the same value, the linear object identifier 2300 may identify that the detected object as the secondary linear object.

Referring to FIG. 4(c), when the wall 4100 is the linear object at a high position, the ultrasonic sensor unit may transmit the ultrasonic waves, and receive the primary direct waves 3100 reflected once from the wall 4100 and the secondary direct waves 3200 reflected once again from the wall 4100 after the primary direct waves 3100 are reflected around the ultrasonic sensor unit. In this case, the secondary direct wave TOF may be about twice the primary direct wave TOF. For example, the error range between the primary direct wave TOF and the secondary direct wave TOF may be within 0.3 m.

The linear object identifier 2300 may identify whether the secondary direct wave TOFs of the first, second, third and fourth ultrasonic sensor units 2110, 2120, 2130, and 2140 have the same value.

When the secondary direct wave TOFs have the same value, and three among the four secondary direct wave TOFs have an error range within a preset value, the linear object identifier 2300 may identify the detected object as the linear object. For example, the error range of three secondary direct wave TOFs may be within 0.15 m.

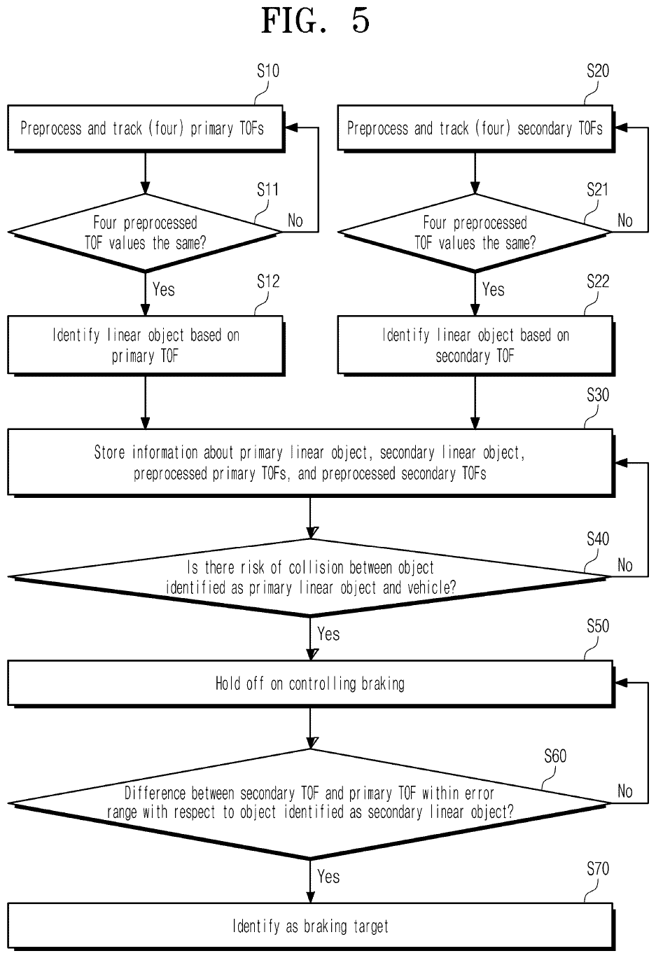

FIG. 5 is a flowchart showing a method of detecting a linear object in an open area according to an embodiment of the disclosure.

Referring to FIG. 5, the apparatus 2000 for detecting a linear object may identify whether an object detected in an open area is a linear object.

To this end, the apparatus 2000 for detecting a linear object may perform tracking by preprocessing the primary TOFs based on the primary waves output from the four ultrasonic sensor units (S10). In this case, the apparatus 2000 for detecting a linear object may perform tracking for up to three cycles, considering a case where primary direct TOF measurement fails.

After S10, the apparatus 2000 for detecting a linear object may identify whether the four preprocessed primary TOF values are the same (S11).

After S11, the apparatus 2000 for detecting a linear object may identify the detected object as the linear object based on the primary TOF when the four preprocessed primary TOF values are the same (S12).

Meanwhile, the apparatus 2000 for detecting a linear object may perform tracking by preprocessing the secondary TOF based on the secondary waves output from the four ultrasonic sensor units (S20). In this case, the apparatus 2000 for detecting a linear object may perform tracking for up to one cycle, considering a case where the secondary direct TOF measurement fails.

After S20, the apparatus 2000 for detecting a linear object may identify whether the four preprocessed secondary TOF values are the same (S21).

After S21, the apparatus 2000 for detecting a linear object may identify the detected object as the linear object based on the secondary TOF when the four preprocessed secondary TOF values are the same (S22).

The apparatus 2000 for detecting a linear object may store information about the primary linear object detected by the primary waves, the secondary linear object detected by the secondary waves, the preprocessed primary TOFs, the preprocessed secondary TOFs, etc. (S30).

After S30, the apparatus 2000 for detecting a linear object may identify whether there is a risk of collision between the object identified as the primary linear object and the vehicle (S40).

After S40, the apparatus 2000 for detecting a linear object may hold off on controlling the braking of the vehicle when there is a risk of collision between the object identified as the primary linear object and the vehicle (S50). In this way, the apparatus 2000 for detecting a linear object may prevent false braking of the vehicle.

After S50, the apparatus 2000 for detecting a linear object may identify whether a difference between the secondary TOF and the primary TOF is within an error range with respect to the object identified as the secondary linear object (S60). For example, the error range between the secondary TOF and the primary TOF may be twice the primary TOF.

After S60, the apparatus 2000 for detecting a linear object may identify the secondary linear object as a braking target when the difference between the secondary TOF and the primary TOF within a preset error range with respect to the object identified as the secondary linear object (S70). The apparatus 2000 for detecting a linear object may transmit a braking flag corresponding to the braking target to a braking device of the vehicle.

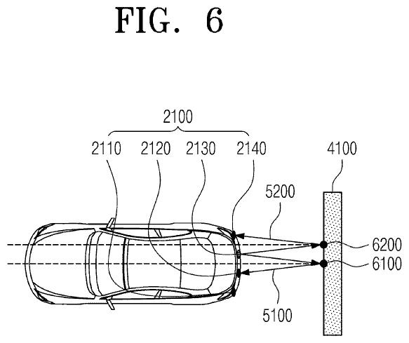

FIG. 6 is a diagram illustrating a method of detecting a linear object in a parking space according to an embodiment of the disclosure.

Referring to FIG. 6, the linear object identifier 2300 according to an embodiment of the disclosure may receive the direct wave TOF based on the direct waves and the indirect wave TOF based on the indirect waves from the ultrasonic signal preprocessor 2200. In this case, the direct wave TOF may have the same distance value of the signals between a sensor Tx of transmitting the ultrasonic waves and a sensor Rx of receiving the ultrasonic waves, and the indirect wave TOF may have different distance values of the signals between the sensor Tx of transmitting the ultrasonic waves and the sensor Rx of receiving the ultrasonic waves.

In the present embodiment, it will be described by way of example that the third ultrasonic sensor unit 2130 is the sensor Tx of transmitting the ultrasonic waves, and the second ultrasonic sensor unit 2120 and the fourth ultrasonic sensor unit 2140 are the sensors Rx of receiving the indirect waves.

Specifically, the linear object identifier 2300 may identify whether the direct wave TOF by the third ultrasonic sensor unit 2130 and the direct wave TOF by the second ultrasonic sensor unit 2120 adjacent to the third ultrasonic sensor unit 2130 have the same distance value.

When the direct wave TOF by the third ultrasonic sensor unit 2130 and the direct wave TOF by the second ultrasonic sensor unit 2120 adjacent to the third ultrasonic sensor unit 2130 have the same distance value, the linear object identifier 2300 may identify whether the indirect wave TOF received from the third ultrasonic sensor unit 2130 by the second ultrasonic sensor unit 2120 is present.

When the indirect wave TOF received from the third ultrasonic sensor unit 2130 by the second ultrasonic sensor unit 2120 is present, the linear object identifier 2300 may calculate an ideal indirect wave TOF of when the second ultrasonic sensor unit 2120 receives the direct wave TOF. In this case, the ideal indirect waves based on the linear object may be a signal reflected from a midpoint between the two ultrasonic sensor units 2120 and 2130.

In this case, the second ultrasonic sensor unit 2120 receives sound waves reflected at the shortest distance, and thus a Y value at a point of the linear object 4100, where the indirect waves are reflected, may be equal to a Y value 6100 between the third ultrasonic sensor unit 2130 and the adjacent ultrasonic sensor unit, i.e., the second ultrasonic sensor unit 2120. In this case, the location of the linear object may be set as coordinates on a XY plane.

For example, an ultrasonic signal 5100 transmitted from the third ultrasonic sensor unit 2130 is reflected at a midpoint 6100 between the adjacent second ultrasonic sensor unit 2120 and the third ultrasonic sensor unit 2130, and the second ultrasonic sensor unit 2120 may receive the reflected ultrasonic signal 5100 as the indirect waves.

The linear object identifier 2300 may compare the indirect wave TOF received from the second ultrasonic sensor unit 2120 with the calculated ideal indirect wave TOF.

The linear object identifier 2300 may output a linear object flag when a comparison result is within the error range. For example, the difference between the received indirect wave TOF and the calculated ideal indirect wave TOF may be within the error range of 1 cm.

In addition, the linear object identifier 2300 may output a linear object flag based on the direct wave TOF and the indirect wave TOF according to the third ultrasonic sensor unit 2130 and the adjacent fourth ultrasonic sensor unit 2140.

Further, the linear object identifier 2300 may identify whether the direct wave TOF by the third ultrasonic sensor unit 2130 and the direct wave TOF by the fourth ultrasonic sensor unit 2140 adjacent to the third ultrasonic sensor unit 2130 have the same distance value.

When the direct wave TOF by the third ultrasonic sensor unit 2130 and the direct wave TOF by the fourth ultrasonic sensor unit 2140 adjacent to the third ultrasonic sensor unit 2130 have the same distance value, the linear object identifier 2300 may identify whether the indirect wave TOF received by the fourth ultrasonic sensor unit 2140 from the third ultrasonic sensor unit 2130 is present.

When the indirect wave TOF received by the fourth ultrasonic sensor unit 2140 from the third ultrasonic sensor unit 2130 is present, the linear object identifier 2300 may calculate an ideal indirect wave TOF of when the fourth ultrasonic sensor unit 2140 receives the direct wave TOF. In this case, the ideal indirect waves based on the linear object may be a signal reflected from a midpoint between the two ultrasonic sensor units 2130 and 2140.

In this case, the fourth ultrasonic sensor unit 2140 receives sound waves reflected at the shortest distance, and thus a Y value at a point of the linear object 4100, where the indirect waves are reflected, may be equal to a Y value 6200 between the third ultrasonic sensor unit 2130 and the adjacent fourth ultrasonic sensor unit 2140.

For example, an ultrasonic signal 5200 transmitted from the third ultrasonic sensor unit 2130 is reflected at a midpoint 6200 between the adjacent fourth ultrasonic sensor unit 2140 and the third ultrasonic sensor unit 2130, and the fourth ultrasonic sensor unit 2140 may receive the reflected ultrasonic signal 5200 as the indirect waves.

The linear object identifier 2300 may compare the indirect wave TOF received from the fourth ultrasonic sensor unit 2140 with the calculated ideal indirect wave TOF.

The linear object identifier 2300 may output a linear object flag when a comparison result is within the error range.

Therefore, the linear object identifier 2300 may accumulate the linear object flags, and identify the detected object as the linear object when the accumulated value is greater than or equal to a threshold value.

Meanwhile, the linear object identifier 2300 may initialize the accumulated value when the linear object flags are not continuously detected more than the threshold value.

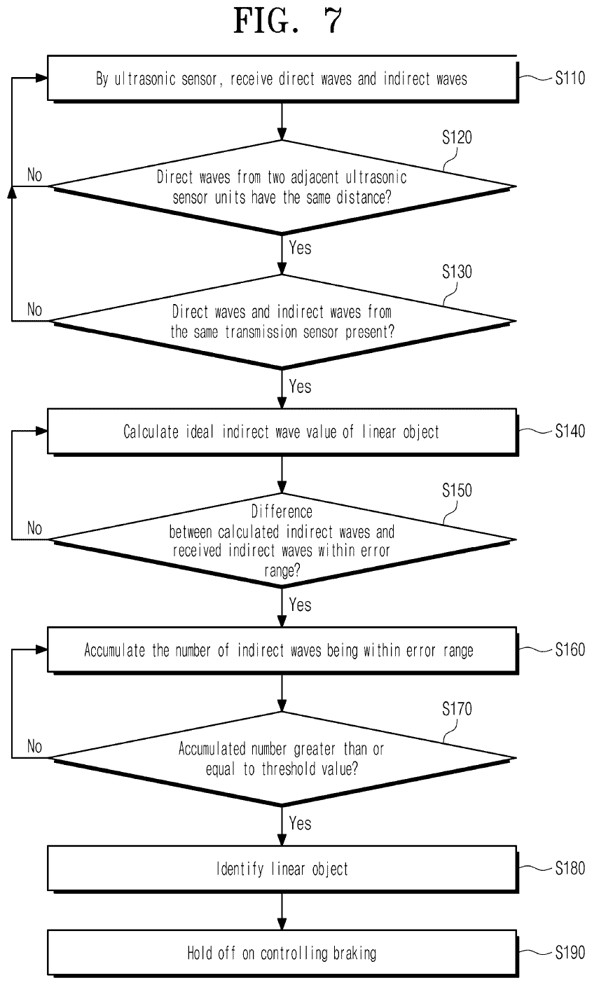

FIG. 7 is a flowchart showing a method of detecting a linear object in a parking space according to an embodiment of the disclosure.

Referring to FIG. 7, the apparatus 2000 for detecting a linear object may identify whether the object detected in the parking space is the linear object.

To this end, the apparatus 2000 for detecting a linear object may receive the direct wave TOF and indirect wave TOF (S110).

After S110, the apparatus 2000 for detecting a linear object may identify whether the direct waves from two adjacent ultrasonic sensor units among the plurality of ultrasonic sensor units have the same distance value (S120).

After S120, when the direct waves from the two adjacent ultrasonic sensor units have the same distance value, the apparatus 2000 for detecting a linear object may identify whether the direct waves and the indirect waves from the same transmission sensor are present, (S130).

After S130, when the direct waves and the indirect waves from the same transmission sensor are present, the apparatus 2000 for detecting a linear object may calculate an ideal indirect wave value corresponding to the linear object (S140).

After S140, the apparatus 2000 for detecting a linear object may identify whether a difference between the calculated indirect waves and the received indirect waves is within an error range (S150).

After S150, when the difference between the calculated indirect waves and the received indirect waves is within the error range, the apparatus 2000 for detecting a linear object may accumulate the number of indirect waves being within the error range (S160).

After S160, the apparatus 2000 for detecting a linear object may identify whether the accumulated number is greater than or equal to a threshold value (S170).

After S170, when the accumulated number is greater than or equal to the threshold value, the apparatus 2000 for detecting a linear object may identify the detected object as the linear object (S180).

After S180, the apparatus 2000 for detecting a linear object may hold off on controlling the braking of the vehicle to prevent false braking of the vehicle (S190).

Any one of embodiments of the disclosure has an effect on preventing false braking of a vehicle by identifying a low linear object with a primary ultrasonic wave and identifying a high linear object with a secondary ultrasonic wave.

The effects obtainable in the disclosure are not limited to the above-mentioned effects, and other effects not mentioned above may be clearly understood by those skilled in the art from the following description.

In other words, the technical idea of the disclosure may be applied to the entire autonomous vehicle or may also be applied only to some elements in the autonomous vehicle. The scope of the disclosure is based on the matters disclosed in the appended claims.

As another aspect of the disclosure, the foregoing operations of the proposal or disclosure may be provided as a code that can be implemented, performed or executed by a “computer (comprehensive concept including a system on chip (SoC), a microprocessor, etc.),” an application storing or including the code, a computer-readable storage medium or a computer program product, etc., which also falls within the scope of the present invention.

The detailed descriptions of the exemplary embodiments of the disclosure disclosed above have been provided to enable those skilled in the art to implement and embody the disclosure. Although the descriptions have been made with reference to the exemplary embodiments of the disclosure, it will be understood by those skilled in the art that various modifications and changes can be made without departing from the scope of the disclosure. For example, those skilled in the art can use a combination of elements described in the foregoing embodiments.

Accordingly, the disclosure is not intended to be limited to the foregoing embodiments, but is to be accorded the widest scope consistent with the principles and novel features disclosed herein.

What is claimed is:

1. An apparatus for detecting a linear object, the apparatus comprising:
an ultrasonic sensor comprising first, second, third and fourth ultrasonic sensor units, each of which is configured to transmit a signal toward an object and receive signals of direct waves and indirect waves reflected from the object;
an ultrasonic signal preprocessor configured to preprocess the direct waves and indirect waves received in each of the first, second, third and fourth ultrasonic sensor units and detect a direct wave time-of-flight (TOF) and an indirect wave TOF;
a linear object identifier configured to identify the linear object based on at least one of the direct wave TOF and the indirect wave TOF; and
a controller configured to control braking of a vehicle based on the linear object.

2. The apparatus of claim 1, wherein the ultrasonic signal preprocessor comprises:
an ultrasonic signal primary wave preprocessing unit configured to set a distance value of a first signal, which exceeds a preset reference among the detected TOFs, as a primary TOF; and
an ultrasonic signal secondary wave preprocessing unit configured to set a distance value of a second signal, which exceeds a preset reference among the detected TOFs, as a secondary TOF.

3. The apparatus of claim 2, wherein the linear object identifier is further configured to:
identify the object as a primary linear object based on the primary TOF, upon all the same preprocessed primary direct wave TOF values; and
identify the object as a secondary linear object based on the secondary TOF, upon all the same preprocessed secondary direct wave TOF values.

4. The apparatus of claim 3, wherein the controller is further configured to hold off on controlling the braking of the vehicle, upon a risk of collision between the primary linear object and the vehicle.

5. The apparatus of claim 4, wherein the controller is further configured to identify whether the secondary direct wave TOF value is twice the primary direct wave TOF value, upon presence of the secondary linear object.

6. The apparatus of claim 5, wherein the controller is further configured to:
identify the secondary linear object as a braking target, upon the secondary direct wave TOF value twice the primary direct wave TOF, and
control the braking corresponding to the braking target.

7. The apparatus of claim 2, wherein the linear object identifier is further configured to:
select two adjacent ultrasonic sensor units among the first, second, third and fourth ultrasonic sensor units; and
identify whether the direct wave TOFs received in the selected ultrasonic sensor units have the same distance value.

8. The apparatus of claim 7, wherein the linear object identifier is further configured to select one of the two adjacent ultrasonic sensor units as a transmission sensor and the other as a reception sensor, upon the direct wave TOFs received in the selected ultrasonic sensor units and having the same distance value.

9. The apparatus of claim 8, wherein the linear object identifier is further configured to calculate an ideal indirect wave TOF corresponding to a linear object, upon the reception sensor receiving the indirect waves from the transmission sensor.

10. The apparatus of claim 9, wherein the linear object identifier is further configured to:
identify whether a difference between the indirect wave TOF based on the received indirect waves and the ideal indirect wave TOF is within an error range;
accumulates a number of the indirect waves, upon the difference being within the error range; and
identify the object as the linear object, upon the accumulated number of the indirect waves being greater than or equal to a threshold value.

11. A method of detecting a linear object, the method comprising:
by each of first, second, third and fourth ultrasonic sensor units, transmitting a signal toward an object and receiving signals of direct waves and indirect waves reflected from the object;
preprocessing the direct waves and indirect waves received in each of the first, second, third and fourth ultrasonic sensor units to detect a direct wave time-of-flight (TOF) and an indirect wave TOF;
identifying the linear object based on at least one of the direct wave TOF and the indirect wave TOF; and
controlling braking of a vehicle based on the linear object.

12. The method of claim 11, wherein the preprocessing the direct waves and indirect waves received in each of the first, second, third and fourth ultrasonic sensor units to detect the direct wave TOF and the indirect wave TOF comprises:
setting a distance value of a first signal, which exceeds a preset reference among the detected TOFs, as a primary TOF; and
setting a distance value of a second signal, which exceeds a preset reference among the detected TOFs, as a secondary TOF

13. The method of claim 12, wherein the identifying the linear object based on the at least one of the direct wave TOF and the indirect wave TOF comprises:
identifying the object as a primary linear object based on the primary TOF, upon all the same preprocessed primary direct wave TOF values; and
identifying the object as a secondary linear object based on the secondary TOF, upon all the same preprocessed secondary direct wave TOF values.

14. The method of claim 13, wherein the controlling of the braking of the vehicle based on the identified linear object comprises holding off on controlling the braking of the vehicle, upon a risk of collision between the primary linear object and the vehicle.

15. The method of claim 14, wherein the controlling of the braking of the vehicle based on the identified linear object comprises identifying whether the secondary direct wave TOF value is twice the primary direct wave TOF value, upon presence of the secondary linear object.

16. The method of claim 15, further comprising:
identifying the secondary linear object as a braking target, upon the secondary direct wave TOF value twice the primary direct wave TOF, and
controlling the braking corresponding to the braking target.

17. The method of claim 12, wherein the identifying of the linear object based on the at least one of the direct wave TOF and the indirect wave TOF comprises:
selecting two adjacent ultrasonic sensor units among the first, second, third and fourth ultrasonic sensor units; and
identifying whether the direct wave TOFs received in the selected ultrasonic sensor units have the same distance value

18. The method of claim 17, further comprising selecting one of the two adjacent ultrasonic sensor units as a transmission sensor and the other as a reception sensor, upon the direct wave TOFs received in the selected ultrasonic sensor units and having the same distance value.

19. The method of claim 18, further comprising calculating an ideal indirect wave TOF corresponding to a linear object, upon the reception sensor receiving the indirect waves from the transmission sensor.

20. The method of claim 19, further comprising:
identifying whether a difference between the indirect wave TOF based on the received indirect waves and the ideal indirect wave TOF is within an error range;
accumulating a number of the indirect waves, upon the difference being within the error range; and
identifying the object as the linear object, upon the accumulated number of the indirect waves being greater than or equal to a threshold value.
